(19) United States
(12) Patent Application Publication
(10) Pub. No.: US 2011/0110999 A1
(43) Pub. Date: May 12, 2011

(54) METHOD OF MANUFACTURING NATURAL OR SYNTHETIC FIBERS CONTAINING SILVER NANO-PARTICLES

(75) Inventors: Anna Facibeni, Milano (IT); Carlo Enrico Bottani, Milano (IT); David Dellasega, Milano (IT); Fabio Di Fonzo, Milano (IT); Matteo Paolo Bogana, Milano (IT)

(73) Assignee: POLITECNICO DI MILANO, Milano (IT)

(21) Appl. No.: 12/990,024

(22) PCT Filed: Apr. 23, 2009
(86) PCT No.: PCT/EP2009/002953

§ 371 Date: Dec. 15, 2010

(30) Foreign Application Priority Data
Apr. 30, 2008 (IT) MI2008A000792

(51) Int. Cl. A01N 25/08; A01N 59/16; A01P 1/00; B82Y 30/00

(52) U.S. Cl. 424/404; 424/409; 424/618; 977/773

(57) ABSTRACT

There is described a method for the deposition of silver nanoparticles on the surface of natural or synthetic textile fibers.

The present invention concerns a simplified method for the deposition of silver nano-particles on the surface of natural or synthetic fibers.

It is known that the ions of some metals can destroy or inhibit the reproduction of unicellular organisms such as microbes and bacteria; in particular, silver ions seem to have the most important antibacterial properties. This feature is exploited for producing deodorants (some bad smells, e.g. in the clothes, are due to by-products of microorganisms metabolism) and, in particular, products with disinfectant properties.

Silver, in the form of metallic elements having size greater than one millimetre, releases ions too slowly and it is not suitable for the above mentioned applications. On the contrary, silver salts or complexes in solution or, for instance, impregnated in clothes, cause a too fast release of ions, thus quickly losing their antibacterial properties.

In recent years it was observed that particles of metallic silver having sub-micrometric size, and in particular lower than 100 nanometres (nm), have an accelerated release of silver ions with a consequent large increase of the antibacterial activity; it is believed that this is due to their high superficial area (area per weight unit) and to the consequent surface energy of this silver form, which causes a chemical instability of the atoms on the surface greater than that of metallic elements of visible size.

Many methods for functionalizing bodies or systems with silver nano-particles have been proposed; in particular, the research focused on the functionalization of fibers or textiles, which represents the easiest and the most convenient form of use for bringing the silver nano-particles into contact with parts of the human body.

The Korean Paten Application N. 10-2006-0047094 A discloses a method for manufacturing polymeric fibers comprising silver nano-particles, by forming the nano-particles, covering them with a layer of silicon oxide for avoiding oxidation and aggregation thereof to obtain particles of greater size, mixing under stirring the nano-particles with dust or small pieces of polymer to be functionalized for making a mechanical mixture as homogeneous as possible, and finally bringing the mixture to the polymer melting temperature and obtaining the functionalized fibers through spinning of the melt.

The US Patent Application N. 2006/0202382 A1 discloses a method of fabricating nano-silver fibers, which comprises producing in a solution the nano-particles by reacting a silver salt with a reducing agent in the presence of a dispersing agent (the latter having the function of avoiding aggregation and excessive growth of the nano-particles), successively dissolving a polymer in the solution, and finally spinning the thus obtained dense solution.

The International Patent Application WO 2006/135128 A1 discloses a method for manufacturing nanosilver-adsorbed fibers wherein an aqueous suspension of nano-particles is produced by applying a high potential difference (from 10.000 to 300.000 V DC) between two silver electrodes dipped into water, and allowing only a low current to flow between the two electrodes; under such conditions, the inventors affirm to be able to control the size of the nano-particles to values lower than 5 nm. Successively, the fibers to be functionalized are dipped into the thus obtained aqueous suspension and the adhesion of the nano-particles to the surface thereof is caused through processes such as thermal fixation, high frequency radiation, or the like.

The International Patent Application WO2007/032001 A2 discloses a method for the preparation of silver-polymer composites which comprises making a solution of a silver salt in a solvent based on polyols (e.g. ethylene glycol), introducing dusts or flakes of the polymer to be functionalized into the solution, and subjecting the latter to ultrasonic irradiation, which causes the formation of silver nano-particles on the polymer surface; the thus obtained coated polymer is then spun to obtain functionalized fibers.

The International Patent Application WO 2007/032567 A1 discloses a method for manufacturing silver nano-particles consisting in vaporizing a solution of a silver salt in a chamber of a thermal reactor, in order to make the solvent to evaporate and to cause the decomposition of the salt for forming the nano-particles; the thus obtained nano-particles are collected, mixed with dusts or flakes of a polymer, and the mixture is spun to obtain the functionalized fibers.

All these known methods, however, present drawbacks. Firstly, in the majority of cases (except for the method disclosed in WO 2006/135128 A1), a portion of the silver nano-particles remains embedded inside the fiber instead of being at the surface thereof, thereby showing a reduced ions release activity. Furthermore, the known methods, including the method disclosed in WO 2006/135128, present the intrinsic limit of functionalizing only synthetic fibers with silver nano-particles. Finally, all these methods are quite complex (and thus expensive) and not directly applicable to the textile industry, thereby requiring changes and adjustments of the traditional working procedures.

The present invention provides a method for manufacturing textile fibers containing silver nano-particles, which can be indifferently applied to natural or synthetic fibers, allowing the nucleation of silver nanoparticles on the fibers surface, and which is easily integrated in the normal production processes of the textile industry.

The method according to the present invention comprises the reaction between silver ions and a reducing agent in an aqueous or hydro-alcoholic solution in which the fibers to be functionalized are present.

According to known processes, silver nano-particles are firstly produced and then allowed to adhere to the textile fibers by means of different methods. On the contrary, according to the present invention the formation of the nano-particles and their adhesion to the fibers surface occur at the same time.

The method of the invention allows to prepare natural and synthetic fibers carrying silver nanoparticles (“nano-silver fibers” or “fibers functionalised with silver nano-particles”), e.g. cotton, linen, viscose, acetate (an acetyl cellulose derivative) or polyesters. The fibers can be dipped into the solution in the form of free fibers, yarn or already in the form of textile. The use in this method of free or spun fibers allows the successive manufacture of textiles comprising also silver-free threads, whereby the silver amount in the textile can be modulated, while the use of a textile provides the advantage of obtaining a product that is practically finished at the end of the process. Accordingly, as used herein, the term “fibers” indicates indifferently free, spun or woven fibers, unless otherwise specified.

The reaction between silver ions, Ag⁺, and the reducing agent is carried out in the solution in which the fibers are present. The Ag⁺ ions can be obtained from the dissociation of a silver salt soluble in water, e.g. perchlorate, AgClO₄, or preferably nitrate, AgNO₃. The reducing agent can be, for instance, ascorbic acid, a reducing sugar such as glucose or fructose, or a citrate, preferably sodium citrate.

The solution wherein the reaction is carried out can be obtained in different ways. For instance, it is possible to introduce the desired water amount in a suitable container, dissolving the first reactant (typically the silver salt) in water, and successively adding the reducing agent in the thus obtained solution; alternatively, it is possible to prepare two separate aqueous solutions, one with the silver salt and the other with the reducing agent, and successively combining the two solutions, preferably slowly and under stirring.

The concentration of the solutions may be different in the two cases, i.e. depending on whether one single solution, containing a first reactant which is then added with a second reactant in solid form, or two separate solutions are used.

In the first case, it is preferable that the reactant already in solution is the silver salt, and that the reducing agent is added to this solution (which contains the fibers). When this procedure is followed, the starting solution containing a silver salt has a preferred concentration from 10⁻³ to 10⁻² M; concentrations lower than 10⁻³ M may reduce the coating of the fibers with silver nano-particles, while concentrations higher than 10⁻² M may render the solution cloudy, when the reducing agent is added, and produce silver agglomerate deposits on the fibers instead of nano-particles.

In the second case (mixture of two solutions of different reactants), the same concentrations as in the first case are used for the silver salt solution, while the concentration of reducing agent preferably varies from 10⁻² to 5×10⁻¹ M for citrate solutions, from 8×10⁻⁴ to 5×10⁻² for ascorbic acid solutions and from 10⁻¹ to 5×10⁻¹ M for reducing sugars. These concentrations of reducing agent secure high reaction rates and yields on industrial scale without stiffening of the treated textile.

The reaction between the silver ions and the reducing agent is preferably carried out at a temperature ranging from 40 to 100° C.; in order to reach the highest reaction rate for industrial applications, the solution is preferably heated to 40-60° C., more preferably to about 50° C., when the reducing agent is ascorbic acid; to 92-100° C., more preferably to about 95° C. when the reducing agent is a citrate or a reducing sugar.

The fibers can be placed in the solution any time before the reaction is started. For instance, when a solution containing both the silver ions and the reducing agent is prepared, it is sufficient to introduce the fibers into the solution before the reaction temperature is reached; if instead the reaction is carried out by slowly adding a reactant (e.g., the reducing agent in solid form or in solution) to a solution containing the other reactant and maintained at the required temperature, the fibers are preferably already present in the starting solution. The weight ratio between silver and fibers may vary, but optimum ratio values were found around 2 g of silver per 100 g of fibers.

Optionally, a dispersing agent can be added to the solution to prevent agglomeration of the silver nano-particles thereby avoiding the formation of too large sized particles; this function is optimally performed by the citrate ion, which can be either used alone (in this case performing the double function of reducing and dispersing agent) or added as a third component in case ascorbic acid or sugars are used as reducing agents. The use of the citrate ion as reducing and dispersing agent in reactions for the production of nano-particles of gold was disclosed in the article “A study of the nucleation and growth processes in the synthesis of colloidal gold”, by J. Turkevich et al., Discuss. Faraday Soc. (1951), vol. 11, pages 55-75, which however concerned the formation of gold colloidal systems and not of silver nano-particles on fibers surface as in the present invention.

The invention will be further illustrated by the following examples.

### EXAMPLE 1

### Test for the Production of Fibers Carrying Silver Nano-Particles

A solution containing 2×10⁻³ M of AgNO₃ (Aldrich) was prepared in a beaker by dissolving 340 mg of the salt in one litre of water. 40 cm of cotton thread was introduced into the solution, wound on a rubber support so as to keep it well tight. The AgNO₃ solution was brought to 90° C. under light stirring. Apart a solution containing 3.4×10⁻² M of trisodium citrate (Fluka) was prepared by dissolving 1 g of the salt in 0.1 l of water; the citrate solution was added drop by drop to the nitrate solution. At the beginning a slight clouding of the resulting solution was observed, which became in sequence yellow, red, green, till it became completely cloudy after the citrate solution was added. At this point the reaction was interrupted by quickly cooling through dipping the beaker into cold water. The fibers were drawn out of the beaker, washed with distilled water, dried and examined under electron microscope. The microscope analysis showed that the fibers were almost fully coated with silver particles having size lower than about 100 nm, with only few particles having higher size.

### EXAMPLE 2

### Further Test for the Production of Silver Nano-Particles on Fibers

A solution containing 1.42×10⁻³ M of ascorbic acid (Aldrich) was prepared; 10 ml of this solution was introduced into a beaker and heated at 50° C. on the plate of a magnetic stirrer; 20 cm of cotton thread was introduced into the solution. Apart a second solution was prepared by mixing 10 ml of a 2×10⁻³ M of AgNO₃ solution and 1 ml of a 3.5×10⁻² M of trisodium citrate solution. This second solution was added drop by drop to the ascorbic acid solution under stirring, and the mixture was allowed to react at constant temperature for one hour. At the end of the test the fibers were collected, washed and dried, and they showed the presence of silver particles having size from about 20 nm to about 50 nm.

### EXAMPLE 3

The test of Example 1 was repeated, but in this case 1 g of solid fructose was added to the AgNO₃ solution through three successive doses of 250 mg, 250 mg and 500 mg, respectively. At the end of the test the fibers were recovered from the solution, washed and dried, and the electron microscope analysis showed the presence of silver particles having size lower than 50 nm.

### EXAMPLE 4

### Washing Resistance Tests on Fibers Obtained with the Method of the Invention

A AgNO₃ aqueous solution was prepared by dissolving 360 mg of the salt in 1 l of water; 60 ml of this solution were taken and introduced into a beaker. A 150 cm long white cotton thread was wound onto a rubber O-ring, which was successively dipped into the AgNO₃ solution; the solution was slightly stirred and brought to 93° C. 3.6 ml of a 3.4×10⁻² M trisodium citrate solution was added under quick stirring; the reaction was allowed to proceed for 20 minutes. The O-ring was extracted from the solution and the cotton thread was retrieved, which resulted dark. The thread was washed and air-dried, and the SEM analysis showed the coating with silver nano-particles. The thread was cut into 9 cm long pieces. Three pieces underwent washing tests with a commercial detergent having the following composition: 5-15% by weight of anionic surfactants; non-ionic surfactants lower than 5%; phosphorus lower than 0.5%; and various additives. The washings were carried out according to the AATCC standard “Standard for home laundering fabrics prior to flammability testing to differentiate between durable and non-durable finishes”, by using 0.2 ml of detergent in 10 ml of water for each washing. The washings were performed at 35-40° C. for 8 minutes, with rotation speed of 100 rounds per minute; the first piece was washed in these conditions for 18 minutes, the second one for 90 minutes and the third one for 180 minutes; the washings for 90 and 180 minutes simulate cycles of 5 and 10 washings respectively. After washing, each thread piece was rinsed and allowed to air-dry for one day.

Successively the silver residual deposits of the three thread pieces and of a comparative piece which had not undergone any washing were measured. The residual deposit was evaluated according to the following method. Each thread piece was dipped for 90 minutes into 30 ml of a 50% by volume solution of nitric acid; in such a way the whole silver present on the thread passed into the solution. The thus obtained solution was poured into a PFA volumetric flask and brought to 100 ml with distilled water. 0.1 ml was taken from this new solution and introduced into a further PFA volumetric flask, 1 ml of concentrated nitric acid was added and the whole was brought to 100 ml with distilled water. A ICP-MS analysis was carried out on the thus obtained solution. The test results, expressed as silver amount (mg of silver per cm of thread) present on the thread pieces after 0, 1, 5 and 10 washings, are reported in Table 1.

TABLE 1

| Number of washings | Silver load of the thread piece (mg/cm) |
|---|---|
| 0 | 0.0215 |
| 1 | 0.0193 |
| 5 | 0.0081 |
| 10 | 0.0056 |

The results in the table confirm that even after the tenth washing, silver is present on the thread, which in fact appears still dark at visual inspection.

### EXAMPLE 5

Tests for determining the antibacterial properties of fibers prepared with the method of the invention. The method involved measurement of the “Zone of Inhibition” (ZOI), which consists in the introduction of the test sample in a bacterial culture maintained in a Petri dish, and evaluating the width in millimetres of the area free of bacteria around the sample.

Cotton, viscose, acetate and polyester threads were prepared following the procedure of Example 1. Four 1.5 cm long samples were taken from each thread. Apart bacterial cultures of the following four stocks were prepared: Escherichia coli K12; Pseudomonas aeruginosa; Enterococcus faecium; and Staphylococcus aureus. For each bacterial stock type, 8 cultures were prepared in Petri dishes. A “matrix test” was obtained by depositing one piece of each of the above described nanosilver-functionalised threads into each different bacterial culture, for a total of 16 tests; a thread of size and material similar to those cited above, but non-functionalized with silver nano-particles was also deposited in each different culture, thereby obtaining a total of additional 16 comparative tests. The results of these tests are reported in Table 2, where the numerical values indicate the width of the area (in mm) around the sample where the bacterial growth was inhibited. “Inv.” indicates the thread obtained according to the invention and “Comp.” indicates the untreated, comparative thread.

TABLE 2

| | Fiber | | | | | | | |
|---|---|---|---|---|---|---|---|---|
| | Cotton | | Viscose | | Acetate | | Polyester | |
| Bacterium | Comp. | Inv. | Comp. | Inv. | Comp. | Inv. | Comp. | Inv. |
| Escherichia coli | 0 | 1.5 | 0 | 0.2 | 0 | 0.1 | 0 | 1 |
| Pseudomonas a. | 0 | 0 | 0 | 0.2 | 0 | 0 | 0 | 2.7 |
| Streptococcus f. | 0 | 1.5 | 0 | 0 | 0 | 0 | 0 | 2.5 |
| Staphylococcus a. | 0 | 1 | 0 | 0 | 0 | 0 | 0 | 1 |

### EXAMPLE 6

### Tests for Determining the Antibacterial Activity of Fibers Prepared According to the Invention

Two sets of sterile test tubes with screw plug (Falcon™) were provided; in the following the two sets are referred to as set a) and b), respectively, which consist of four test tubes each; a further test tube, in the following referred to as c), was provided too. 50 microlitres of inoculant were introduced into each test tube of sets a) and b), while a 6 cm long thread containing silver nano-particles according to the procedure of Example 1 was introduced into each test tube of set b) and into test tube c); in so doing, the four test tubes of set a) contained the inoculant, but not the nanosilver thread, and thus were used as the negative control; the four test tubes of set b) contained both the inoculant and the nanosilver thread and thus represented the test sample; finally, the test tube c), containing the thread but not the inoculant, was used as positive control. The thread sample was introduced into the test tubes of set b) and into the test tube c) under flux hood, in order to secure the highest sterility to the test. 20 ml of a 0.9% neutralizing saline solution was poured into one test tube of set a), one test tube of set b) and into test tube c), immediately after the introduction of inoculant and/or nanosilver thread, to determine the number of bacteria present at the beginning of the test (zero time, t₀); immediately after, the test tubes were closed. In the remaining test tubes of sets a) and b) the bacterial cultures were allowed to grow by incubation at 37° C., for 1 h (t₁), 6 h (t₂) and 24 h (t₃), respectively, then neutralizing the cultures with 20 ml of saline solution and immediately closing the test tube at the indicated times. Finally, the test tubes were opened and their content poured into plates which carried a culture soil prepared apart, referred to as “Nutrient Broth”; said soil was prepared from 5 g of Bacto-peptone and 3 g of “Beef extract” diluted to 1000 ml with distilled water, boiling so as to obtain the complete dissolution of the components, adjusting the pH to 6.8 with NaOH 1 N and finally sterilizing the solution for 15 minutes. The obtained plates were incubated for 24 h.

At the end of this period the percentage of reduction of bacteria was calculated as reported in the AATCC-100 protocol and respectively in the article by S. H. Jeong et al, J. Material Science (2003) 38 2199-2204.

The results of the tests for cotton and polyester nanosilver-functionalized fibers challenged with cultures of Escherichia coli and Staphylococcus aureus, are reported in Table 3 and indicate the bacterial activity reduction from cultures containing the nanosilver thread compared to cultures without nanosilver thread.

TABLE 3

| | Tested organism | | | |
|---|---|---|---|---|
| | Escherichia coli | | Staphylococcus aureus | |
| Treated textile | Cotton-Ag | Polyester-Ag | Cotton-Ag | Polyester-Ag |
| % reduction 24 h | 92% | n.a. | n.a. | n.a. |
| AATCC-100 | | | | |
| % reduction 24 h | 95% | n.a. | 90% | 93% |
| S. H. Jeong | | | | |
| % reduction 6 h | n.a. | 98% | n.a. | n.a. |
| AATCC-100 | | | | |
| % reduction 6 h | 97% | 99% | 99% | 85% |
| AATCC-100 | | | | |
| S. H. Jeong | | | | |

The results of Tables 2 and 3 show that the nanosilver fibers of the invention are able to inhibit the bacterial growth, particularly in the case of cotton and polyester fibers.

1. A method of manufacturing textile fibers carrying silver nanoparticles adhered thereto, said method comprising reacting silver ions from a silver salt with a reducing agent in an aqueous solution in the presence of fibers.

2. A method according to claim 1, wherein said fibers are natural or synthetic fibers.

3. A method according to claim 2, wherein said fibers are selected from cotton, linen, viscose, acetate and polyesters.

4. A method according to claim 1, wherein said fibers are present in said solution in the form of free fibers, yarn or textile.

5. A method according to claim 1, wherein said silver ions are disassociated from a water soluble silver salt selected from AgClO₄ and AgNO₃.

6. A method according to claim 1, wherein the reducing agent is citrate, ascorbic acid or a reducing sugar.

7. A method according to claim 6, wherein the citrate is trisodium citrate.

8. A method according to claim 6, wherein the reducing sugar is glucose or fructose.

9. A method according to claim 1, wherein the aqueous solution contains from 10⁻³ to 10⁻² M of silver salt.

10. A method according to claim 1, wherein the aqueous solution is prepared by combining two separate aqueous solutions, containing the silver salt and the reducing agent, respectively.

11. A method according to claim 10, wherein the aqueous solution containing the silver salt has a concentration of from 10⁻³ to 10⁻² M.

12. A method according to claim 10, wherein the reducing agent is citrate at a concentration of from 10⁻² to 10⁻¹ M.

13. A method according to claim 10, wherein the reducing agent is ascorbic acid at a concentration of around 10⁻³ M.

14. A method according to claim 10, wherein the reducing agent is a sugar at a concentration of from 10⁻¹ to 5×10⁻¹ M.

15. A method according to claim 1, wherein the reaction occurs at a temperature ranging from 40 to 100° C.

16. A method according to claim 1, further comprising adding a dispersing agent to the reaction mixture.

17. A method according to claim 16, wherein said dispersing agent is trisodium citrate.
